(19) United States
(12) Patent Application Publication
(10) Pub. No.: US 2003/0067947 A1
(43) Pub. Date: Apr. 10, 2003

(54) Laser control circuit for maintaining constant power and extinction ratio

(76) Inventors: Yong-Shan Zhang, San Jose, CA (US); Vinodkumar Ramadrishnan, Santa Clara, CA (US)

Correspondence Address: David H. Jaffer, Pillsbury Winthrop LLP, 2550 Hanover Street, Palo Alto, CA, 94304-1115, US

(21) Appl. No.: 09/975,080

(22) Filed: Oct. 10, 2001

(51) Int. Cl. H01S 3/13

(52) U.S. Cl. 372/29.021

(57) ABSTRACT

A laser transmitter with a laser diode and first and second feedback loops for maintaining a constant average laser power output and constant extinction level. A photo detector samples and detects transmitter laser light. The detector output is split, with one portion sent to a low-pass detector circuit for detecting the average laser power and using the detected signal to control a laser power current bias source. The other portion of the detector output is delivered to a high-pass detector circuit for detecting the amplitude of the modulation for outputting a signal to control a modulation laser current source that adds to the power current bias for a logic “1” state and does not add to the power bias for a logic “0” state.

### BACKGROUND OF THE INVENTION

1. Field of the Invention

The present invention relates generally to circuitry for control of lasers, and more particularly to a circuit including feedback networks for regulating the laser output optical power and extinction ratio in communication equipment.

2. Description of the Prior Art

Application of electrical current to a laser diode causes the diode to convert the electrical energy to stimulated emission of light. In digital modulation of a laser diode, a high current diode bias generates a bright light, and a low current generates a dim light. The two different intensities of light represent the logic states of “1” and “0”. An ideal laser diode generates light intensity that changes with modulating data/current, while maintaining a constant wavelength and average power. A real laser power (P) versus current (I) characteristic changes with temperature and aging. The lasing threshold current of a diode increases with an increase in temperature, and also increases with age. To keep the laser output power level constant, it is common to detect the optical power with a photo detector (back facet) diode and use a feedback loop to control the laser diode bias current. Another problem that occurs is a change in transmitted wavelength when the diode current is changed from that required for a logic “1” state to a logic “0” state. This phenomenon is known as frequency chirping. This change/fluctuation in wavelength causes distortion of the modulation waveform as a result of dispersion when the light passes through optical fibers, resulting in a degradation of system performance especially at high data rates. Frequency chirping is a function of extinction ratio, defined as the ratio of the power level (P₁) of a laser when in the logic “1” state, to the power level (Pₒ) of the laser when in the logic “0” state. In order to minimize the effect of chirping, it is necessary to control the extinction ratio of the laser output. If only the average output optical power of the laser is constant, the extinction ratio can change dramatically with temperature or aging. One approach to controlling the extinction ratio is to modulate the laser with a low frequency, and detecting a portion of the laser light by a photo (back facet) diode. The detected low frequency signal is then fed back to control the laser biasing current so that it remains on the power (P) versus current (I) characteristic at a constant dP/dI point.

U.S. Pat. No. 5,850,409 by Link describes a laser modulation control apparatus that controls the extinction ratio of a semiconductor laser. A relative low frequency pilot tone changes the amplitude of modulation current at a small but fixed percentage. The corresponding light intensity will also be changing at the frequency of the pilot tone. By detecting the amplitude of the slow varying light intensity, the amplitude of modulation by data is also determined since the pilot tone changes the data modulation current at a fixed ratio. The modulation amplitude of light intensity by data can be controlled in a feedback loop. A second loop controls the average power by changing the bias current. The extinction ratio is determined if average optical power and modulation amplitude are kept constant.

There are several issues that could limit the use of this scheme. First, the L-I characteristic changes with temperature and aging. Therefore, in an un-cooled laser the extinction ratio will change with temperature. In a cooled laser, the extinction ratio will also change as the laser ages. Second, some optical transmitters superimpose a low rate data on the high rate data path and this low rate data and pilot tone could interfere with each other. Third, the pilot tone modulation could introduce some power penalty in optical receive sensitivity.

U.S. Pat. No. 4,796,266 by Misaizu describes a laser diode bias current circuit for maintaining a constant laser threshold current. A low frequency signal is applied to modulate both bias current source and modulation current course. The light intensity variation at the low frequency will be a measurement of bias current and the amplitude of variation is fed back to keep average bias current constant. A second loop keeps average modulation current constant.

This scheme has the advantage that the light signal has a constant envelope. But, as the bias current is modulated near the lasing threshold, the extinction ratio will change periodically. Therefore, only the average extinction ratio is kept constant. The periodic change of extinction ratio introduces a power penalty. Besides, the average extinction ratio will also be varying due to the temperature change or laser aging.

Briefly, a preferred embodiment of the present invention includes a laser transmitter with a laser diode and first and second feedback control loops for maintaining a constant average laser power output and constant extinction ratio. A photo detector samples and detects transmitted laser light. The detector output is split, with one portion sent to a low-pass detector circuit for detecting the average laser power and using the detected signal to control a laser power current bias source. The other portion of the detector output is delivered to a high-pass detector circuit for detecting the amplitude of the modulation for outputting a signal to control a modulation laser current source that adds to the current bias for a logic “1” state and does not add to the laser current for a logic “0” state.

### IN THE DRAWING

FIG. 1 is a block diagram of the laser transmitter with first and second feedback loops;

FIG. 2 is a plot of laser power versus diode current;

FIG. 3 is a more detailed circuit diagram of the transmitter of FIG. 1;

FIG. 4 is a copy of the circuit of FIG. 3 with the added incorporation of AC coupled modulation; and

FIG. 5 is a circuit diagram of a microwave detector.

### DETAILED DESCRIPTION OF THE PREFERRED EMBODIMENT

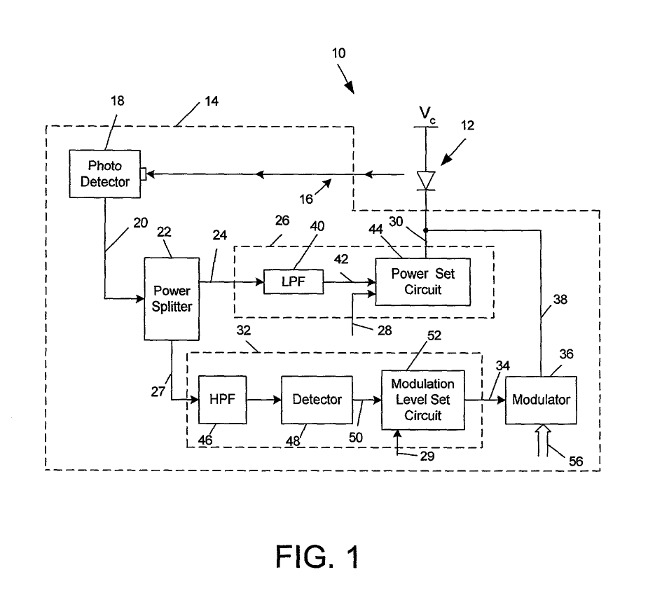

Referring now to FIG. 1 of the drawing, a preferred embodiment of the present invention is illustrated as including a system 10 having a laser 12 and a feedback laser control circuit 14 for modulating laser power, and for controlling the average laser power and the laser output extinction ratio. The laser 12 in response to a bias current emits a corresponding light beam 16. The circuit 14 includes a photo detector 18 that samples the beam 16 and detects and outputs the modulation as an electrical signal on line 20 to a power splitter 22. A first output signal at 24 from the splitter 22 is processed by a first bias circuit 26 that separates out a low frequency component that represents the average output power of the laser 12. The circuit 26 compares this low frequency component with a power level reference 28 and outputs a control signal at 30 for current biasing the laser 12 to cause diode 12 to draw the appropriate amount of current for a prescribed power level. A second output signal at 27 from the splitter 22 is sent to a second bias circuit 32. The second bias circuit 32 detects a high frequency component of the modulation and compares it with a reference signal at 29 for outputting a modulation current control signal at 34 for controlling the modulation level of a modulator 36 so as to provide a laser modulation level bias at 38 for maintaining a constant extinction ratio.

A preferred embodiment of the first bias circuit 26 includes a low pass filter 40 that selects out the low frequency component of the modulation, which is input at 42 to a power bias set circuit 44. The circuit 44 compares the signal at 42 and the power reference signal at 28 and provides a corresponding current source at 30 to cause the laser 12 to draw the required current to output a predetermined average power level.

A preferred embodiment of the second bias circuit 32 includes a high pass filter 46 for selecting out the higher frequency components of the laser modulation. A high frequency detector 48, preferably microwave frequency, detects the high frequency components and outputs a corresponding DC (direct current) signal at 50. A modulation level set circuit 52 receives the input at 50 and an input reference level signal at 29, and in response outputs a corresponding modulation level control signal at 34 to adjust the modulator to set the extinction ratio at a predetermined value. The modulator 36 in response to a modulation input 56, sources a current (Imod) to diode 12 as indicated by line 38. The level of the modulation, i.e., the value of Imod, is set in response to the input 34, and determines the extinction ratio.

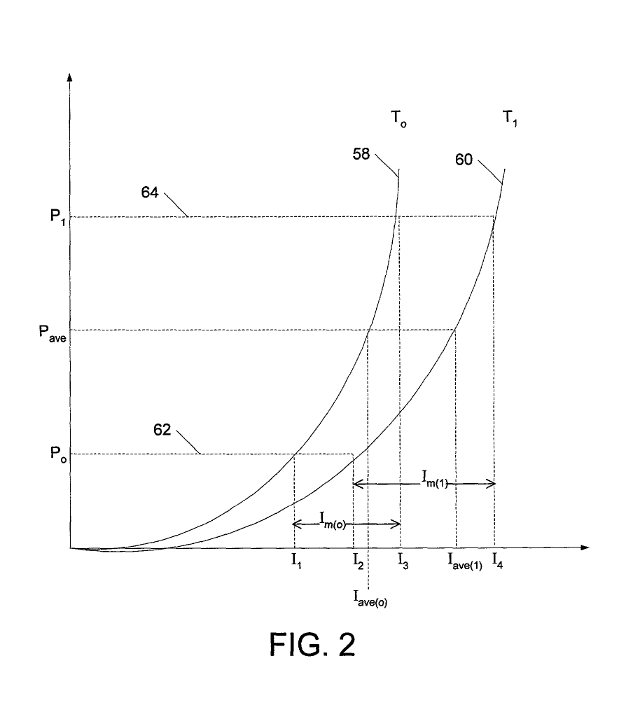

FIG. 2 of the drawing shows a plot of laser output power (P) as a function of laser diode current (I). Two curves 58 and 60 are shown to illustrate a change in the laser diode characteristic curve. The change in the curve could be due to aging, or a temperature change, or other influential factor. Line 62 represents a low level laser power Pₒ when the diode is driven by the modulator to a logic “0” state. Line 64 represents a high level laser power P₁ when the diode is driven by the modulator to a logic “1” state. For purposes of illustration, it will be assumed that curve 58 is the diode P-I characteristic when the laser is at a temperature Tₒ, and curve 60 is the characteristic at temperature T₁. Assuming that the desired laser setting is originally achieved at temperature Tₒ, the increase in modulation current required for driving the laser from power Pₒ to P₁ is Im(o)=I₃−I₁. At temperature T₁, the increase in modulation current required is Im(1)=I₄−I₂. The control of the change in modulation current Im required to switch between Pₒ and P₁ is accomplished as described above by the second bias circuit 32. The absolute value of the laser 12 output power level is controlled by the first bias circuit 26. According to FIG. 2, the average power at temperature Tₒ is (P₁+Pₒ)/2=Pₐᵥₑ and requires an average current of Iₐᵥₑ (o). The function of circuit 26, however, is to set a diode bias current source at 30 that will cause the laser to output the required average power Pₐᵥₑ. The circuit of the preferred embodiment of FIG. 1 therefore does not set a laser bias current at 30 of Iₐᵥₑ. The feedback circuit 26 will set a bias current at 30 to a value of I₁ at temperature Tₒ for example. Circuit 36 adds an additional current at temperature Tₒ of I₃−I₁=Im(o). The combination of the settings of circuit 32 and 26 results in an average power of Pₐᵥₑ=(P₁+Pₒ)/2

At temperature Tₒ, the circuit 26 provides a current source at point 30 of value I₁. At temperature T₁, the circuit 26 raises the current source at 30 to I₂. The circuit 32 provides direction to modulator 36 to provide a current source at 38 of value I₃-I₁ at temperature Tₒ for a logic “1” state. At temperature T₁, circuit 32 directs modulator 36 to provide a current source at 38 of I₄-I₂ for a logic “1” state. Other modulation methods for use in FIG. 1 will be apparent to those skilled in the art, and these are also included in the spirit of the present invention. For example, modulator 36 could be set to provide a non-zero bias at logic “0” with a higher bias at logic “1”. In this case, the bias at 30 from circuit 26 would be a lesser value by the amount of the logic “0” bias of the modulator.

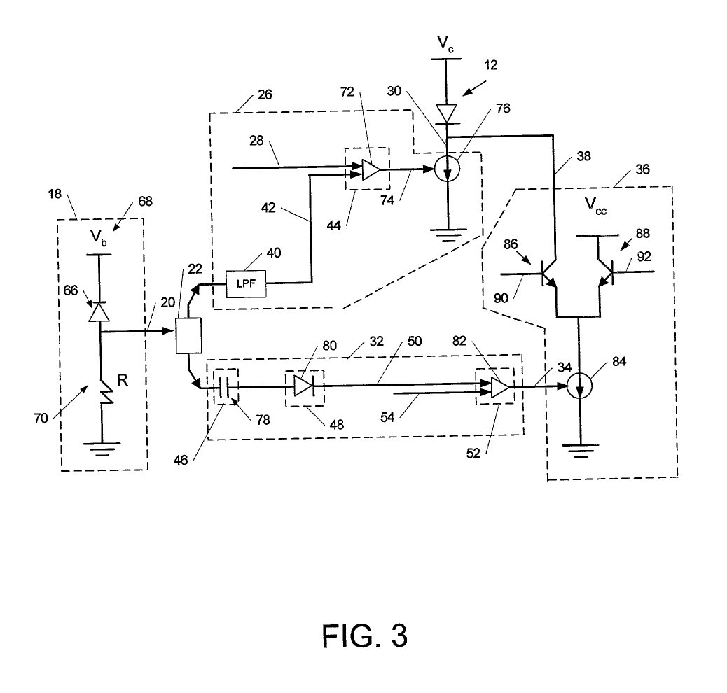

A preferred embodiment of the circuitry of FIG. 1 is illustrated in more detail in FIG. 3. The laser 12 is shown to be powered by a DC supply V_{c}. The detector 18 includes a back facet detector photo diode 66, DC power source 68 and a bias resistor 70. The output 20 of the detector 18 provides input to the power splitter 22. A portion (preferably half) of the power goes to the first bias circuit 26, which includes the low pass filter 40. The power set circuit 44 is shown in FIG. 3 to preferably be an integrator 72 feeding output 74 to control a current source 76 providing the current bias to laser 12.

The second bias circuit 32 is shown to include the high pass filter 46 illustrated as a series capacitor 78. The detector 48 is shown to preferably include a Schotky diode 80 microwave detector giving output at 50 to the modulator level set circuit 52, which includes an integrator 82 which responds to the input on line 50 and the reference level at 54 to provide the control output at 34 to the modulator 36.

The modulator 36 is shown in FIG. 3 to include a current source 84 providing the required modulation current as discussed in reference to FIG. 2 and controlled by the second bias circuit 32 output at 34 to maintain a constant power ratio, i.e., extinction value. Modulation switching circuitry is preferably configured as shown to include two transistors 86 and 88 that are emitter coupled to the current source 84. Transistor 88 is connected to a power supply V_{cc}. In operation, with an input to base 90 a positive high, and input to base 92 a negative low, transistor 86 is turned on and transistor 88 is off. This condition connects the current source 84 to the laser 12 via connection 38. The result is that the modulation current source 84 level is added to the power bias current source 76 and the laser outputs the logic “1” power level P₁. When base 90 is a negative and base 92 is high, transistor 86 is turned off and the current source 84 is disconnected from the laser 12. At this point, the laser is biased at the lower current level provided by source 76, resulting in a lower laser power of Pₒ indicative of the logic “0” state.

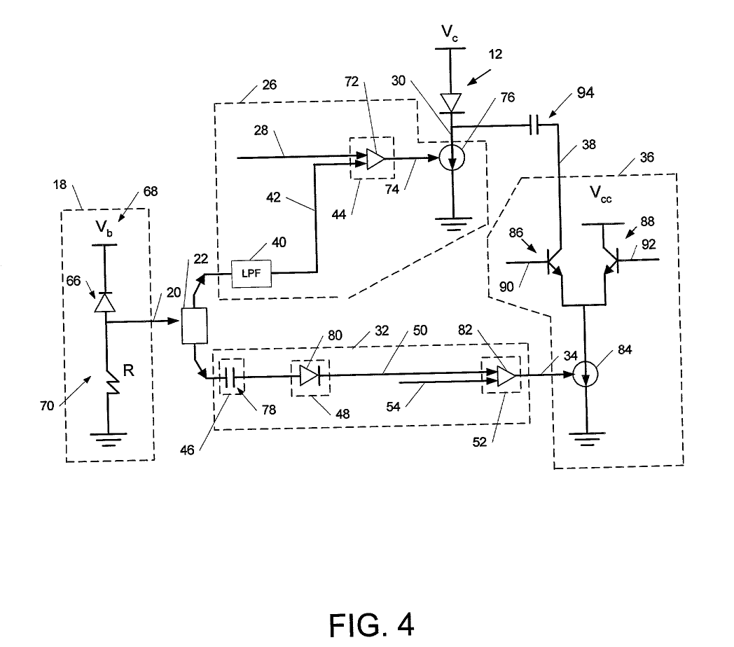

FIG. 4 is a circuit that is identical to FIG. 3, except for AC coupling of the modulator, as evidenced by capacitor 94.

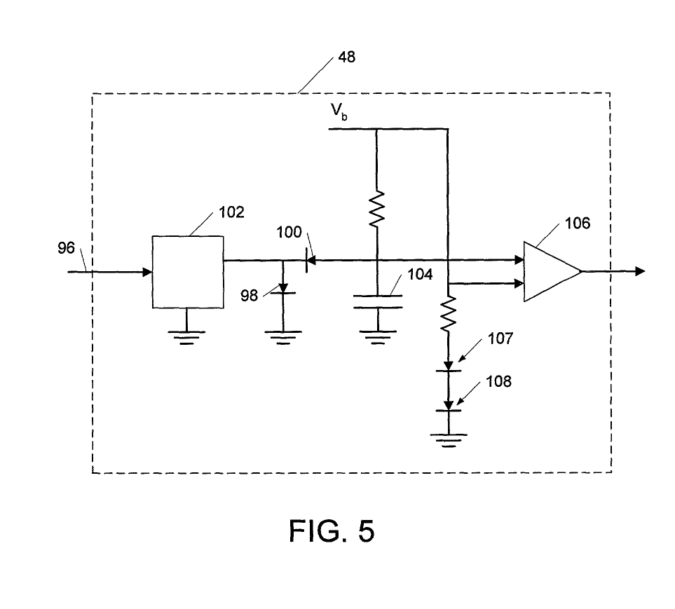

FIG. 5 illustrates a circuit diagram for a typical microwave detector 48 for detecting the signal level of the high frequency modulation signal component. Port 96 is for reception of input from high pass filter 46 and is coupled to detector diodes 98 and 100 by a matching network 102. The capacitor 104 is effectively a low pass filter for allowing only the DC component to pass to amplifier 106. The diodes 107 and 108 provide compensation for performance characteristic changes that occur due to changes in temperature. The circuitry as shown in FIG. 5 will be understood by those skilled in the art.

Although the present invention has been described above in terms of a specific embodiment, it is anticipated that alterations and modifications thereof will no doubt become apparent to those skilled in the art. It is therefore intended that the following claims be interpreted as covering all such alterations and modifications as fall within the true spirit and scope of the invention.

What is claimed is:

1. An apparatus for controlling power level and extinction ratio of a laser transmitter comprising:
(a) a first control loop for sampling a laser diode output power, and detecting and applying a low frequency component of said power for controlling a power level current bias of said laser diode to maintain a constant average of said power; and
(b) a second control loop for said sampling, and for detecting and applying a high frequency component of said power for maintaining a constant modulation laser diode bias current.

2. An apparatus as recited in claim 1 wherein said first and second control loops include in common a photo detector for performing said detecting.

3. An apparatus as recited in claim 2 wherein said first and second control loops include a power splitter in common, wherein said splitter has a first output to a first bias circuit of said first control loop, and a second output to a second bias circuit located within said second control loop.

4. An apparatus as recited in claim 3 wherein said second control loop includes a modulator having a modulation bias current source for providing said modulation laser diode bias current.

5. An apparatus as recited in claim 4 wherein said modulator includes a switch for connecting and disconnecting said modulation bias current source from said laser diode.

6. An apparatus as recited in claim 4 wherein said first bias circuit includes:
(a) a low pass filter; and
(b) a power set circuit responsive to an output signal from said low pass filter, and responsive to a power reference signal, to provide a power level laser diode current bias.

7. An apparatus as recited in claim 6 wherein said second bias circuit includes:
(a) a high pass filter;
(b) a high frequency detector for detecting a signal output from said high pass filter; and
(c) a modulation level set circuit responsive to an output from said high frequency detector and a modulation level reference signal, to output a modulation control signal to control said modulator bias current source.

8. An apparatus as recited in claim 7 wherein said power set circuit includes an integrator.

9. An apparatus as recited in claim 7 wherein said modulation level set circuit includes an integrator.

10. A laser transmitter module comprising:
(a) a laser diode;
(b) an apparatus for controlling power level and extinction ratio of said laser transmitter, said apparatus including
(i) a first control loop for sampling an output power of said laser diode, and detecting an applying a low frequency component of said power for controlling a power level current bias of said laser diode to maintain a constant average of said power; and
(ii) a second control loop for said sampling, and for detecting and applying a high frequency component of said power for maintaining a constant modulation laser diode bias current.

11. A hybrid circuit module for use in controlling power level and extinction ratio of a laser transmitter, said module comprising:
(a) a power splitter having an input for reception of a signal detected from an output of said laser transmitter, and said power splitter having a first output and a second output;
(b) a first bias circuit including
(i) a low pass filter circuit for reception of a first signal from said first output, and for output of a low frequency component of said first signal;
(ii) a power set circuit for comparing a level of said low frequency component with a reference and for applying a corresponding current source to said laser diode to maintain a constant average laser diode output power;
(c) a second bias circuit including
(i) a high pass filer for reception of a second signal from said second output, and for output of a high frequency component of said second signal;
(ii) a detector for detecting a level of said high frequency component of said second signal;
(iii) a modulation level set circuit for comparing said level of said high frequency component with a reference, and outputting a corresponding modulation control signal; and
(iv) a modulator responsive to said modulation control signal to provide a modulation level current source to said diode.
